(19) United States
(12) Patent Application Publication
(10) Pub. No.: US 2008/0252221 A1
(43) Pub. Date: Oct. 16, 2008

(54) Protection device for discharge lamp inverter

(75) Inventor: Chun-Hsiung Chen, Taoyuan Hsien (TW)

Correspondence Address: Joe McKinney Muncy, PO Box 1364, Fairfax, VA, 22038-1364, US

(73) Assignee: SPI ELECTRONIC CO., LTD.

(21) Appl. No.: 11/785,029

(22) Filed: Apr. 13, 2007

(51) Int. Cl. H05B 41/02

(52) U.S. Cl. 315/127

(57) ABSTRACT

The present invention discloses a protection device for a discharge lamp inverter, which is electrically coupled to an inverter outputting at least two opposite-phase powers to drive at least one discharge lamp via at least two power cables. The protection circuit of the present invention comprises the following components: at least two voltage-division units, a detection unit, and a trigger unit. The two voltage-division units are correspondingly electrically coupled to the power cables to obtain the opposite-phase powers and are connected in series at a connection point in the other ends thereof. The detection unit detects the voltage variation of the connection point of the voltage-division units and then generates an abnormal signal. The trigger unit receives the abnormal signal and outputs a protection signal to the inverter to stop outputting power to the discharge lamp.

### FIELD OF THE INVENTION

The present invention relates to a protection device, particularly to a protection device for a discharge lamp inverter, which shuts down power in an abnormal status.

### BACKGROUND OF THE INVENTION

Generally, the electric design and mechanical structure of an electronic product is regulated by related safety standards, such as the LCC (Limit Current Circuit) standard in EN60950 and the electric shock standard in EN60065. In the abovementioned safety standards, the test items include: the touch current and whether the power is interrupted when the resistor having a resistance of 2 K Ω is grounded.

Refer to a R.O.C. patent No. M258540. In the prior art, a lamp inverter drives a plurality of lamps to provide backlight for an LCD and adjust brightness. When EN60065 is applied to test whether the touch current meets the safety standards, a test circuit is electrically coupled to the output of the lamp inverter. The resistor (2 K Ω) of the test circuit is cascaded with the tested object, and a capacitor bridges the resistor. When the test circuit bridges a tube lamp to perform a test, the bridged lamp ceases, but the circuit of the backlight lamps can still operate normally because the lamp inverter is coupled to the lamps via capacitors that stabilize the action of the lamp inverter. The feedback current is the sum of the currents in the test circuit and the lamp. However, the touch current measured in the abovementioned method not only cannot meet the requirement of human safety but also far exceeds the standard of EN60065.

Refer to FIG. 1 a diagram showing the conventional circuit adopting a balance inductor to protect an inverter. In the prior art, when there is a human touch or the 2 K Ω resistor of the test circuit is grounded, the corresponding lamp has a voltage drop (such as a voltage drop from 800V to 600V). Thus, a voltage imbalance exists between the abovementioned lamp and another lamp. The balance inductor is to balance the current flowing between the terminals of the two lamps having voltage difference. A detection unit detects the abnormal rise of voltage and sends an abnormal signal to a trigger unit. The trigger unit sends a protection signal to a power supply unit to shut down the output of power and protect the circuit. However, the balance inductor is very expensive. Besides, different tube lamps have different impedances because of different levels of aging or other factors; then, different tube lamps may have different voltages even in the normal state; for example, one tube lamp has a voltage of 700V, and the other one has a voltage of 900V. Thus, the protection circuit adopting a balance inductor may mistakenly interrupt the output of power because of the different impedances and voltages of the abovementioned two tube lamps. In addition to high cost, the conventional technology also has a disadvantage of low reliability.

In electronic circuits, the similar protection device is also used to solve the problems caused by arc discharge. Arc discharge usually causes the malfunction or damage of electronic elements, or even a fire, which may endanger life. In the traditional high-voltage loads, such as CCFL (Cold Cathode Fluorescent Lamp), EEFL (External Electrode Fluorescent Lamp), anion generators, cathode ray tubes, etc., arc discharge will occur because of the point discharge resulting from an imperfect contact, a humidity/temperature change or a broken/damaged circuit element between the load and the high-voltage power source. U.S. Pat. Nos. 6,940,234 and 6,867,955 disclosed a voltage detection mode to prevent from arc discharge, wherein a voltage-conversion unit of an arc-discharge protection device receives a high-voltage arc-discharge signal from a high-voltage output section and converts the high-voltage arc-discharge signal into a low-voltage arc-discharge signal; a rectifier unit rectifies the low-voltage arc-discharge signal and outputs an arc-discharge noise; a trigger unit detects the arc-discharge noise and outputs a triggering signal to interrupt a control unit or a driving unit lest arc discharge result in heat accumulation on the peripheral elements, which causes a burnout or a fire. Besides, R.O.C. patent publication No. 591976 and No. 591839 disclosed arc-discharge protection devices using a current detection mode.

However, the abovementioned voltage detection mode and current detection mode need a complicated circuit, including the voltage conversion unit, the filter unit, the rectifier unit, etc., which increases the fabrication time and fabrication cost and lays a great burden on manufacturers and consumers.

### SUMMARY OF THE INVENTION

The primary objective of the present invention is to provide a protection device for a discharge lamp inverter, which will interrupt power output when there is a human touch or the resistor of a test circuit is grounded. The present invention has the advantages of high reliability and low material cost. Further, the present invention applies to a push-pull lamp system or a system with multiple lamps driven by a single transformer unit. Besides, no extra loss occurs in the circuit of the present invention.

To achieve the abovementioned objectives, the present invention proposes a protection device for a discharge lamp inverter, which is electrically coupled to an inverter outputting at least two opposite-phase powers to drive at least one discharge lamp via at least two power cables. The protection circuit of the present invention comprises the following components: at least two voltage-division units, a detection unit, and a trigger unit. The two voltage-division units are correspondingly electrically coupled to the power cables to obtain the opposite-phase powers and are connected in series at a connection point in the other ends thereof. The detection unit detects the voltage variation of the connection point of the voltage-division units and then generates an abnormal signal. The trigger unit receives the abnormal signal and outputs a protection signal to the inverter to stop outputting power to the discharge lamps.

### BRIEF DESCRIPTION OF THE DRAWINGS

FIG. 1 is a diagram showing the circuit of a conventional protection circuit adopting a balance inductor.

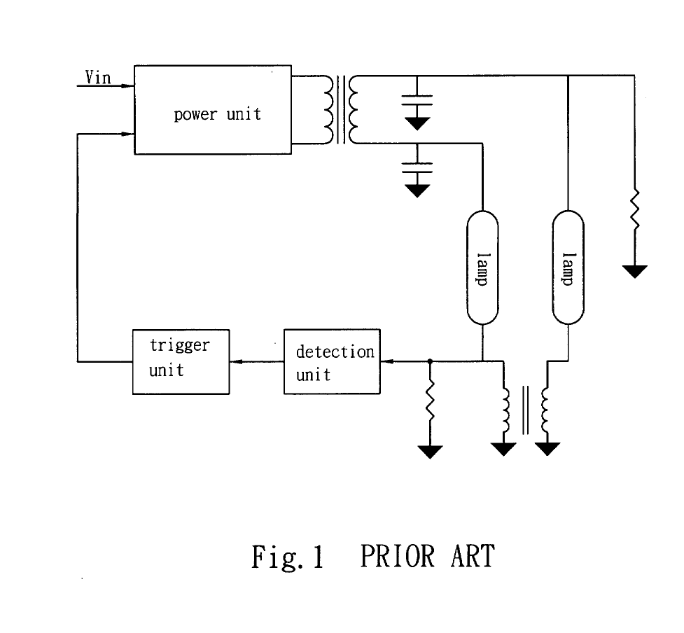

FIG. 2 is a block diagram showing the circuit according to a first preferred embodiment of the present invention.

FIG. 3 is a block diagram showing the circuit according to a second preferred embodiment of the present invention.

FIG. 4 is a block diagram showing the circuit according to a third preferred embodiment of the present invention.

### DETAILED DESCRIPTION OF THE PREFERRED EMBODIMENTS

Below, the technical contents of the present invention are described in detail in cooperation with the drawings.

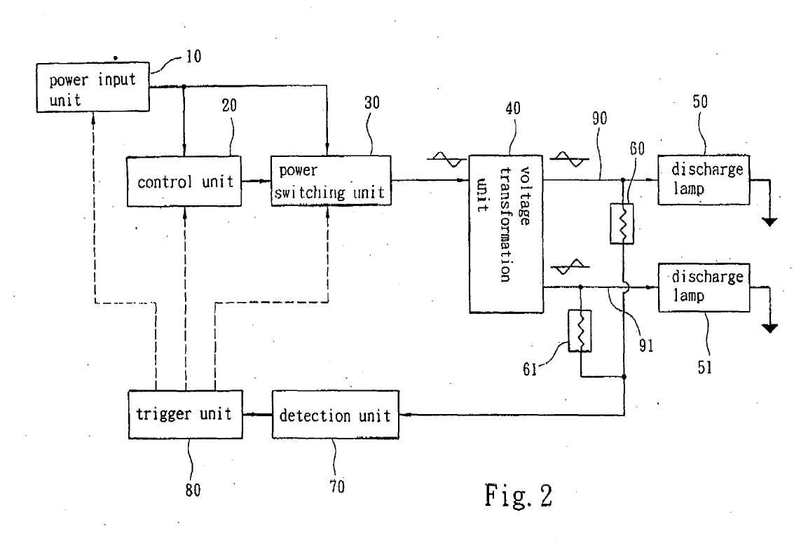

Refer to FIG. 2 a block diagram showing the circuit according to a first preferred embodiment of the present invention. The present invention pertains to a protection device for a discharge lamp inverter. The discharge lamp inverter comprises the following components: a power input unit 10 providing power, a control unit 20 providing voltage distribution signal, a power switching unit 30 receiving the power and the voltage distribution signal and performing voltage conversion, and a voltage transformation unit 40 receiving the converted voltage and transforming the converted voltage into a high voltage. The control unit 20 receives the power from the power input unit 10 and generates frequency signal, which is then sent to the power switching unit 30. The voltage transformation unit 40 is electrically coupled to two discharge lamps 50 and 51 and drives the two discharge lamps 50 and 51 with two opposite-phase powers.

The protection device of the present invention is electrically coupled to the abovementioned inverter, and the inverter outputs at least two opposite-phase powers, which are correspondingly sent to at least one discharge lamp 50, 51 via at least two power cables 90 and 91. The protection device of the present invention comprises the following components: voltage-division units 60 and 61, a detection unit 70, and a trigger unit 80. The voltage-division units 60 and 61 may be bridged resistors and are respectively electrically coupled to the power cables 90 and 91 to obtain the opposite-phase powers. The voltage-division units 60 and 61 are connected in series at a connection point in the other ends thereof. In an abnormal status that a human touches the discharge lamp 50 or 51, or that the resistor of the test circuit is grounded, a voltage difference occurs between the discharge lamps 50 and 51. The voltage difference will change the voltage of the connection point of the voltage-division units 60 and 61; for example, the voltage rises from 0V to 2V. The detection unit 70 detects the voltage variation of the connection point of the voltage-division units 60 and 61 and then generates an abnormal signal. The detection unit 70 is electrically coupled to the trigger unit 80. The trigger unit 80 receives the abnormal signal and outputs a protection signal to the inverter to stop outputting power to the discharge lamps 50 and 51. The protection signal may be sent to the power input unit 10, the control unit 20, or the power switching unit 30. Thereby, power output can be instantly interrupted when there is a human touch or the resistor of a test circuit is grounded.

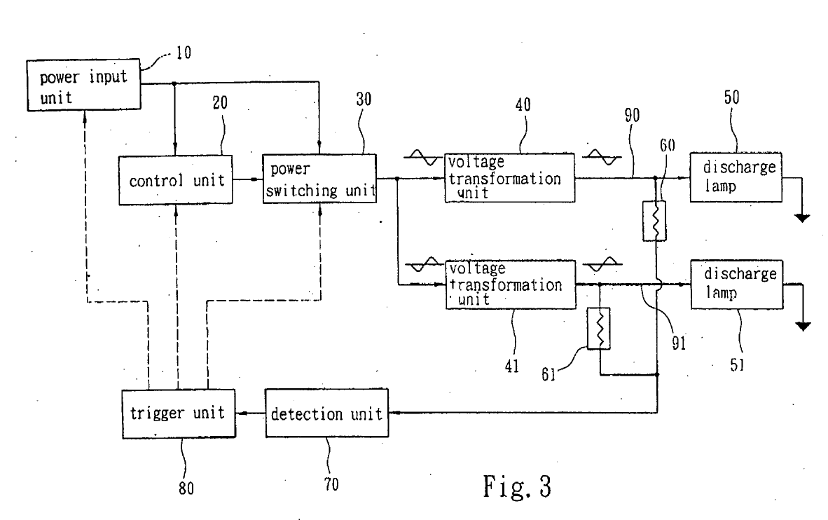

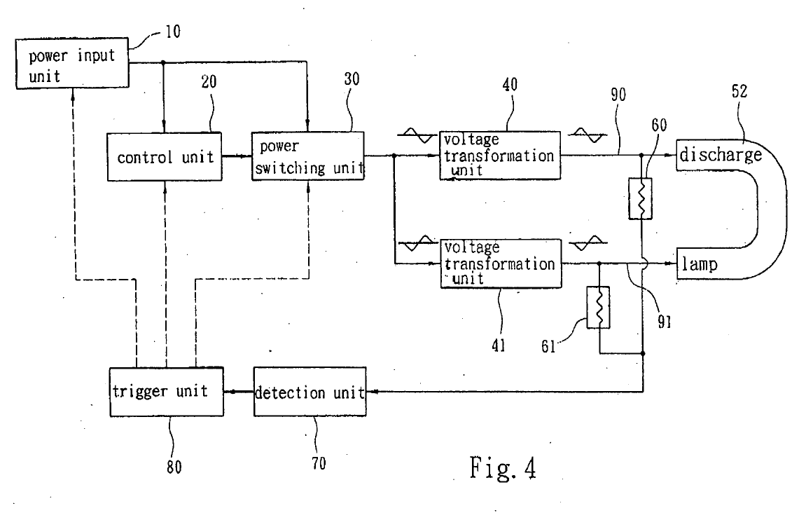

In the first preferred embodiment, the inverter utilizes a single voltage transformation unit 40 to output two opposite-phase powers, which are respectively transmitted via two power cables 90 and 91 to drive at least two discharge lamps 50 and 51, wherein each of the power cables 90 and 91 is singly coupled to the discharge lamp 50, 51. Refer to FIG. 3. In a second preferred embodiment, the inverter utilizes two voltage transformation units 40 and 41 to output two opposite-phase powers; the individual voltage transformation unit 40, 41 drives the discharge lamp 50, 51 via the power cable 90, 91. Refer to FIG. 4. In a third preferred embodiment, the inverter utilizes two voltage transformation units 40 and 41 to output two opposite-phase powers; the voltage transformation units 40 and 41 are respectively coupled, to two input electrodes of a single discharge lamp 52 (such as a U-shape tube lamp) via the power cables 90 and 91. The protection circuit of the present invention applies to all the cases mentioned above. Besides, no extra loss occurs in the protection circuit of the present invention. In comparison with the conventional protection circuit adopting a balance inductor, the present invention has the advantages of high reliability and low material cost.

Those described above are only the preferred embodiments to exemplify the present invention. It is not intended to limit the scope of the present invention. Any equivalent modification or variation according to the spirit of the present invention is to be also included within the scope of the present invention.

1. A protection device for a discharge lamp inverter, which is electrically coupled to an inverter outputting at least two opposite-phase powers to drive at least one discharge lamp via at least two power cables, comprising the following components:
at least two voltage-division units correspondingly electrically coupled to said power cables at one end to obtain said opposite-phase powers and connected at a common connection point at the other ends thereof;
a detection unit detecting the voltage variation of said common connection point of said voltage-division units and then generating an abnormal signal; and
a trigger unit receiving said abnormal signal and outputting a protection signal to said inverter to stop outputting power to said discharge lamp.

2. The protection device for a discharge lamp inverter according to claim 1, wherein each said power cable is singly coupled to a single said discharge lamp.

3. The protection device for a discharge lamp inverter according to claim 1, wherein said power cables are respectively coupled to two input electrodes of a single said discharge lamp.

4. The protection device for a discharge lamp inverter according to claim 1, wherein said inverter comprises a power input unit providing power, a control unit providing voltage distribution signal, a power switching unit receiving said power and said voltage distribution signal and performing voltage conversion, and a voltage transformation unit receiving the converted voltage and transforming said converted voltage into a high voltage.

5. The protection device for a discharge lamp inverter according to claim 4, wherein said inverter utilizes a single said voltage transformation unit to output two opposite-phase powers to drive at least one said discharge lamp via two said power cables.

6. The protection device for a discharge lamp inverter according to claim 4, wherein said inverter utilizes two said voltage transformation units to output two opposite-phase powers, and each said voltage transformation units drives one said discharge lamp via one said power cables.

7. The protection device for a discharge lamp inverter according to claim 4, wherein said protection signal is sent to said control unit.

8. The protection device for a discharge lamp inverter according to claim 4, wherein said protection signal is sent to said power switching unit.

9. The protection device for a discharge lamp inverter according to claim 4, wherein said protection signal is sent to said power input unit.
